(19) United States
(12) Patent Application Publication
(10) Pub. No.: US 2018/0172500 A1
(43) Pub. Date: Jun. 21, 2018

(54) Precision Metering Apparatus for Granular Ingredients

(71) Applicant: 757706 Ontario Inc., Markham (CA)

(72) Inventors: Peyvand Melati Rad, Markham (CA); Antonio Nucaro, North York (CA)

(21) Appl. No.: 15/737,420

(22) PCT Filed: Mar. 29, 2016
(86) PCT No.: PCT/CA2016/000087

§ 371 Date: Dec. 18, 2017

(30) Foreign Application Priority Data
Jun. 19, 2015 (CA) 2,895,014

(51) Int. Cl. G01G 13/28; B65G 53/22; B65D 88/72

(52) U.S. Cl. CPC G01G 13/28; B65D 88/72; B65G 53/22

(57) ABSTRACT

An apparatus for metering granular material, comprising: a container for holding the granular material, the container including a granular material outlet; a mass change measuring device, operatively connected to the container, for measuring a decrease in the mass of the granular material in the container; a granular material forcing apparatus, operatively connected to the container, for selectively forcing granular material out of the container through the granular material outlet; a granular material fluidizer, operatively connected to the container, for fluidizing the granular material within the container during operation of the fluidizer; an electronic controller, operatively connected to the granular material forcing apparatus, for selectively activating and deactivating the granular material forcing apparatus, the controller being operatively connected to the mass change measuring device such that the granular material forcing apparatus is deactivated in response to a predetermined decrease in the mass of the granular material in the container.

### FIELD OF THE INVENTION

This invention relates to the field of precision metering of ingredients, and in particular, to precision metering of granular ingredients.

### BACKGROUND OF THE INVENTION

There are a variety of situations in which it is required to introduce certain ingredients in small amounts as part of a composition. Such situations are common in certain types of manufacturing, such as plastics and pharmaceuticals.

Because the required amounts are small, the metering of such ingredients is preferably as precise as possible for adequate quality control. If the metering is not adequately precise (i.e. if there is a significant likelihood that too much or too little of the ingredient has been introduced), the composition may well need to be discarded, leading to waste and increased cost.

Consider the example of plastics manufacturing. Plastic objects used outdoors often contain an anti-UV additive. A small amount of anti-UV additive, in powdered form, is added to the liquid plastic prior to molding. If too small an amount is added, the anti-UV effect will be inadequate. If too much is added, other properties of the plastic may suffer, and in any event, anti-UV additive would be wasted.

The need for precise metering of granular ingredients has recently increased because of the trend toward concentrated ingredients. Because of the trend toward concentration, granular additives often have a much greater effectiveness per unit of mass or volume of the granular additive than they did in the past. Imprecision can thus lead to worse outcomes than before.

U.S. Pat. No. 6,026,740 describes an apparatus and method for applying salt (a powdered additive) to cheese. The cheese travels across a platform. A sensor measures the weight of the cheese, and a second sensor measures the linear amount of cheese. A negative aspect of this apparatus is that it is effectively limited to essentially solid or semi-solid materials with a linear dimension to be measured that correlates with dosage. Also, salting cheese requires less precision than many other applications.

Chinese patent 103736411 discloses a loss-of-weight powder delivery device. The device comprises a scale, a powder delivery tube, a vacuum box tank, venturi jet means, slurry transfer tubes, powder delivery pumps and control means. A negative aspect of this apparatus is the use of a pump, which adds expense and makes the apparatus prone to breakdown.

### SUMMARY OF THE INVENTION

Therefore, what is desired is an apparatus for metering a granular material that eliminates or improves upon one or more of the negative aspects of the prior art.

Therefore, according to an aspect of the present invention there is provided an apparatus for metering granular material, comprising:

a container for holding the granular material, the container including a granular material outlet;

a mass change measuring device, operatively connected to the container, for measuring a decrease in the mass of the granular material in the container;

a granular material forcing apparatus, operatively connected to the container, for selectively forcing granular material out of the container through the granular material outlet;

a granular material fluidizer, operatively connected to the container, for fluidizing the granular material within the container during operation of the fluidizer;

an electronic controller, operatively connected to the granular material forcing apparatus, for selectively activating and deactivating the granular material forcing apparatus, the controller being operatively connected to the mass change measuring device such that the granular material forcing apparatus is deactivated in response to a predetermined decrease in the mass of the granular material in the container.

### BRIEF DESCRIPTION OF THE DRAWINGS

Reference will now be made, by way of example only, to the figures which illustrate the preferred embodiment of the invention, and in which:

FIG. 1 is a perspective view of an embodiment of an apparatus for metering powder;

FIG. 2 is a top view of an embodiment of an apparatus for metering powder;

FIG. 3 is a schematic diagram of the controller of the apparatus and elements to which it is connected and;

FIG. 4 is a top view of an aerator that is part of a preferred embodiment of the fluidizer of the present invention.

### DETAILED DESCRIPTION OF THE PREFERRED EMBODIMENTS

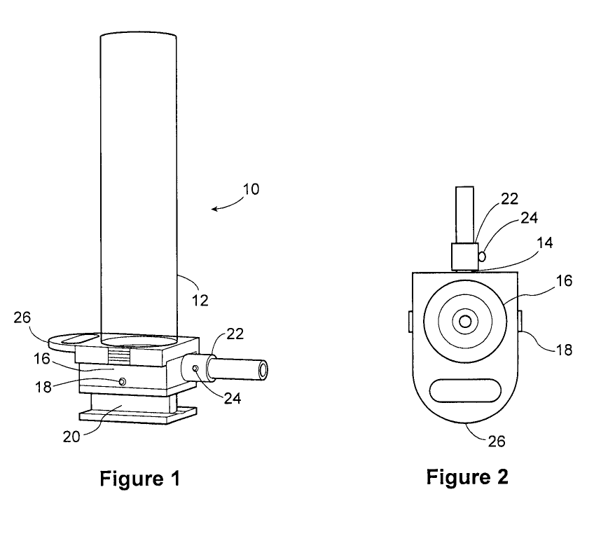

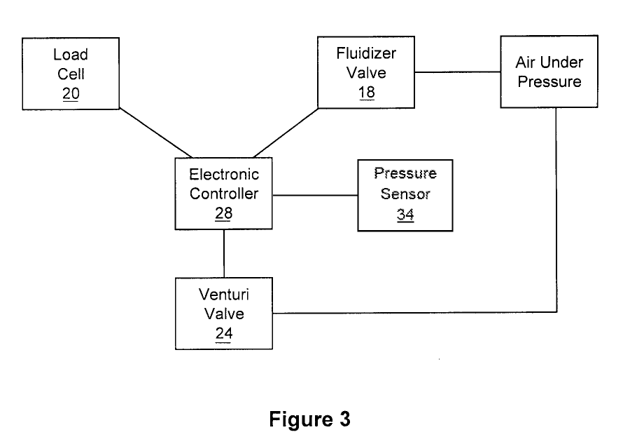

Referring now to FIGS. 1-3, a preferred embodiment of an apparatus 10 for metering powder is shown. The preferred embodiments of the invention are described herein with reference to powder and powdered ingredients, but it will be appreciated that the invention is applicable to granular material, including, for example, microbeads, micro wax, powder, and similar materials. The apparatus 10 comprises a hopper 12, which hopper 12 acts as a container for holding the powder. The hopper 12 includes a powder outlet 14 through which powder exits hopper 12.

The apparatus 10 further comprises a powder fluidizer 16, which includes valve 18. The powder fluidizer 16 is operatively connected to hopper 12. The powder fluidizer 16 functions to fluidize the powder in hopper 12 through the injection of gas (typically air) into the powder in hopper 12. The injection of air is preferably made through valve 18. As will be discussed in more detail below, the injection of air, and valve 18, are preferably controlled by an electronic controller.

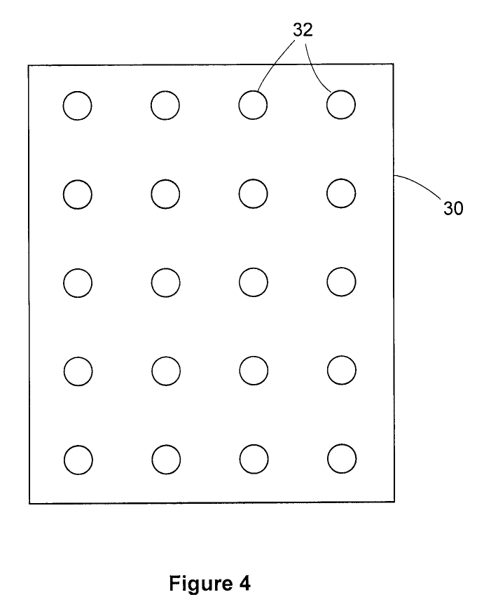

Fluidizer 16 further comprises aerator 30 (FIG. 4). To fluidize powder in the hopper 12, air entering through valve 18 is then directed through aerator 30 so that the air is distributed throughout the powder in hopper 12 to more effectively fluidize it. In the preferred embodiment, aerator 30, a generally planar element with holes 32 distributed therethrough generally in a grid pattern, is oriented and positioned so that the holes 32 in aerator 30 distribute air throughout the generally planar area at the bottom of hopper 12. Most commonly, if apparatus 10 is resting on a horizontal surface, aerator 30 will be oriented generally in a horizontal plane. In the embodiment shown in the Figures, aerator 30 is positioned at a higher vertical position than valve 18 and a lower vertical position than hopper 12.

The apparatus 10 further contains a mass change measuring device, preferably in the form of load cell 20. Load cell 20 is preferably configured to measure a decrease in the mass of the powder in the container.

The present apparatus 10 preferably operates as a loss-of-mass (also known as loss-of-weight) metering apparatus. That is, powder is metered out of the hopper 12, and the electronic controller stops the metering when a particular desired mass of powder has been metered out. The controller knows when that desired massive power has been metered out, because it is operatively connected to the load cell 20, which senses the magnitude of the decrease of mass of the powder in the hopper 12.

The apparatus 10 also preferably includes a powder forcing apparatus, most preferably taking the form of a Venturi vacuum feeder 22 (“Venturi”). The Venturi 22 includes a Venturi valve 24. The Venturi 22 is operatively connected to the hopper 12 via the outlet 14. As will be appreciated by those skilled in the art, the Venturi 22 is operated by the delivery of airflow to Venturi valve 24. This airflow forces powder out of hopper 12, through the outlet 14, by means of the creation of a vacuum in Venturi 22.

In the preferred embodiment, hopper 12 includes quick-release handle 26. Preferably, hopper 12 is coupled to fluidizer 16 by means of a quick-release mechanism (not shown), which is released by pulling on quick-release handle 26. Thus, a hopper 12 can be quickly removed from apparatus 10, and a new hopper 12, with a new supply of powder, may be quickly and efficiently installed on apparatus 10.

The apparatus 10 further comprises electronic controller 28. Electronic controller 28 is preferably operatively connected to each of load cell 20, fluidizer valve 18 and Venturi valve 24.

Fluidizer 16 includes fluidizer valve 18, and a source of gas under pressure, preferably in the form of compressed air 34 in fluid communication with valve 18. Meanwhile, electronic controller 28 is operatively connected to fluidizer valve 18, such that controller 28 opens and closes valve 18 selectively. Thus, controller 28 can selectively cause air to enter hopper 12 by actuating, and thus opening, valve 18. Airflow into hopper 12 can be selectively halted by controller 28 by means of its closing of valve 18.

It will be appreciated by those skilled in the art that the purpose of fluidizing the powder in hopper 12 is to permit the powder 12 to flow out through outlet 14 when Venturi 22 is activated. Because the powder is turned into a quasi-fluid by means of entrainment with air entering through valve 18, the activation of Venturi 22, and the consequent vacuum, will draw the air-powder mixture out through outlet 14.

Controller 28 and fluidizer 16 are preferably configurable to permit selective variation of the powder-to-air ratio during fluidization. It will be appreciated that such variations are desirable, given the varying physical characteristics of powders, and given the varying doses of powdered additives that may be needed in different contexts.

For example, relatively more air may be required to adequately fluidize a powder whose particles are relatively heavy, because such heavier particles have greater inertia and will not flow unless forced by a relatively greater flow of air. By contrast, powders with lighter particles have less inertia and can thus be made to flow with lesser air flow.

Another factor that may influence how much air is entrained with the powder by the fluidizer 16 is the size of the dose of powder that is being metered by the apparatus 10. If the dose is larger, then more airflow may be appropriate, because more airflow will permits a relatively faster metering of powder. By contrast, if the dose is smaller, then less airflow may be appropriate, because it will result in relatively slower metering of powder, which would in turn allow for greater precision.

Load cell 20 is configured to sense the weight (and thus, the mass) of the powder in hopper 12, and to output to controller 28 a signal indicating the sensed weight. When the weight of the powder in hopper 12 decreases as a result of some of the powder having been metered out through outlet 14 and Venturi 22, the load cell 20 senses the change in weight, and outputs to controller 28 a revised signal indicating the decreased sensed weight.

Thus, if it is required to meter out, say, 100 micrograms of powder as part of a composition, controller 28 will activate fluidizer 16 and Venturi 22 to force powder out of hopper 12. Because controller 28 is operatively connected to load cell 20, it receives the aforementioned revised signals from load cell 20 which indicate the progressively decreasing weight of the powder as powder is metered out of hopper 12 through outlet 14 and Venturi 22. Once the controller 28 receives a signal from load cell 20 which indicates a decrease in weight of 100 micrograms, the controller deactivates Venturi 22 to halt the metering of powder out of hopper 12.

In operation, controller 28 selectively opens valve 18 to admit compressed air under pressure into hopper 12 to fluidize the powder. The air travels through valve 18 and aerator 30 to fluidize the powder. In the preferred embodiment, outlet 14 and aerator 30 are both located adjacent to the bottom portion of hopper 12. In this configuration, the portion of the powder fluidized most effectively is the powder near the bottom of hopper 12, because that portion of the powder is entrained with the air immediately as the air exits aerator 30. Thus, outlet 14 is in fluid communication with the fluidized powder near the bottom of hopper 12. This configuration is preferable because it does not require that all of the powder be fluidized. Rather, only sufficient air to fluidize the powder at the lower portion of the hopper 12, and adjacent to outlet 14, is required.

In the preferred embodiment, the hopper 12 is effectively sealed against the entry or exit of air, except that air may flow freely through out of hopper 12 through outlet 14 and Venturi 22. Thus, when fluidizer 16 is activated, pressure builds immediately in hopper 12, and within a fraction of a second, to relieve that pressure from the air entering the hopper, air would flow out through outlet 14 and Venturi 22. Thus, to precisely control the metering of powder the controller 28 preferably activates Venturi 22 (by delivering air 34 at valve 24) within that fraction of a second. This activation creates a vacuum at Venturi 22 which forces air and fluidized powder out of hopper 12 through outlet 14 and Venturi 22. Thus, in the preferred embodiment, the timing of the delivery of compressed air to valve 22 (to activate the Venturi) is coordinated with the timing of the delivery of compressed air to valve 18 (to fluidize the powder). The timing ensures that right after the powder is fluidized, but before any powder is forced out in an uncontrolled manner, Venturi 22 is activated to vacuum powder out of hopper 12, outlet 14 and Venturi 22 in a controlled fashion. When fluidization is halted by the closing of valve 18, promptly thereafter Venturi 22 is deactivated by closing valve 24.

Some prior art metering devices rely on gravity to force powder out of the container into the composition. It is believed that the use of a powder fluidizer is an improvement, because it allows the powder to flow, and together with Venturi 22, be forced out of the hopper 12 in a manner that can be controlled with greater precision than in the prior art. In gravimetric metering devices, the powder flow can be imprecise due to, inter alia, clumping and clogging. It is believed that the use of a fluidizer will reduce the incidence of these problems.

In the preferred embodiment, the controller 28 selectively activates and deactivates the Venturi 22 and fluidizer 16 by pulse-width modulation (PWM). Alternatively, this selective activation and deactivation is done by pulse-frequency modulation (PFM).

PWM is also known as pulse duration modulation. PWM and PFM are related but different techniques for applying a signal. In PWM, the width of pulses is varied at a constant frequency, and the magnitude of the signal is determined by the duty cycle (i.e. the proportion of the period taken up by the pulse). By contrast, PFM is accomplished using fixed-duration pulses and varying their repetition rate (i.e. frequency), and thus, the period.

As an example, in PWM, a new pulse may begin every 0.5 seconds, so that the period of the square wave is 0.5 seconds. However, the width of the pulse is varied in accordance with the magnitude of the signal. For a relatively high magnitude signal, the pulse will take up more of the period (e.g. 0.4 seconds). For a relatively low magnitude signal, the pulse will take up less of the period (e.g. 0.1 seconds). By contrast, in PFM, a pulse would have a fixed width (e.g. 0.1 seconds), but the frequency could be varied upward to increase magnitude or downward to decrease it.

Applied to the present invention, when using PWM or PFM, controller 28 would cycle between “on” (i.e. the pulse) and “off”, with the pulse consisting, in the preferred embodiment, of Venturi 22 and fluidizer 16 being activated to force powder out of hopper 12, and “off” consisting of Venturi 22 and fluidizer 16 being in a deactivated state so that powder is not forced out.

It will be appreciated that PWM and/or PFM are beneficial as a means of control because they can be adjusted according to circumstances. In different manufacturing scenarios, greater or lesser precision may be required; greater or lesser quantities of powder may need to be metered out per unit time; the powder may flow with greater or lesser ease when fluidized. To deal with these parameters, and others, the PWM and/or PFM signals can be adjusted. Thus, for example, when greater precision is required, a higher frequency and/or shorter pulse width may be preferred, because such a signal would meter out less powder per pulse, allowing for greater precision. If a large amount of powder is needed per unit time, a lower frequency and/or longer pulse may be preferred to ensure that the powder is metered fast enough. If the powder does not flow easily, or tends to clog the Venturi 22, a higher frequency with relatively longer pulses may be helpful, to achieve reasonable flow while frequently deactivating the Venturi 22 so as to prevent blockage.

In the preferred embodiment, the apparatus further includes a pressure sensor or pressure transducer 34, operatively connected to the controller 28. Sensor 34 is preferably employed in cases where the hopper 12 is sealed so that the only path out of the hopper 12 for air is through outlet 14. The pressure sensor 34 is preferably positioned in hopper 12 to measure pressure in the hopper 12 within the fluidized powder. As the fluidizer 16 is activated, the pressure within the hopper 12 rises, and in response, as described above, powder should flow out through outlet 14, and such outflow would tend to reduce pressure in hopper 12. If, however, a blockage develops and outflow through outlet 14 is halted or slowed, such a blockage will tend to raise pressure, or at least reduce the rate at which it falls. Thus, it will be appreciated that pressure data communicated by sensor 34 to controller 28 allows controller 28 to respond to blockages, for example, by deactivating fluidizer 16 to permit the blockage to be cleared.

In addition, using data from the pressure sensor 34, controller 28 can determine an expected flow rate of fluidized powder out the hopper 12, since such expected flow rate is based in part on the difference between the pressures inside and outside the hopper 12.

While the foregoing preferred embodiments of the present invention have been set forth in considerable detail for the purpose of making a complete disclosure of the invention, it will be apparent to those skilled in the art that other embodiments described herein are comprehended by the broad scope of the invention as defined in the appended claims.

1. An apparatus for metering granular material, comprising:
a container for holding the granular material, the container including a granular material outlet;
a mass change measuring device, operatively connected to the container, for measuring a decrease in a mass of the granular material in the container;
a granular material forcing apparatus, operatively connected to the container, for selectively forcing the granular material out of the container through the granular material outlet;
a granular material fluidizer, operatively connected to the container, for fluidizing the granular material within the container during operation of the fluidizer;
an electronic controller, operatively connected to the granular material forcing apparatus, for selectively activating and deactivating the granular material forcing apparatus, the controller being operatively connected to the mass change measuring device such that the granular material forcing apparatus is deactivated in response to a predetermined decrease in the mass of the granular material in the container.

2. The apparatus as claimed in claim 1, wherein the granular material forcing apparatus comprises a venturi valve and an air source supplying the venturi valve.

3. The apparatus as claimed in claim 1, wherein the mass change measuring device comprises a load cell.

4. The apparatus as claimed in claim 1, wherein the electronic controller selectively activates and deactivates the granular material forcing apparatus using pulse width modulation.

5. The apparatus as claimed in claim 1, wherein the electronic controller selectively activates and deactivates the granular material forcing apparatus using pulse frequency modulation.

6. The apparatus as claimed in claim 1, wherein the electronic controller is operatively connected to the fluidizer to selectively activate and deactivate the fluidizer.

7. The apparatus as claimed in claim 6, wherein the fluidizer comprises a fluidizer valve and an air source to provide air under pressure to fluidize the granular material, and wherein the fluidizer is activated by opening the fluidizer valve to admit the air under pressure to the container to fluidize the granular material.

8. The apparatus as claimed in claim 1, the apparatus further comprising a pressure sensor, operatively connected to the electronic controller, for measuring a pressure within fluidized granular material in the container.

9. The apparatus as claimed in claim 8, wherein the electronic controller is programmed to use pressure data from the pressure sensor to determine a presence of a granular material flow blockage.

10. The apparatus as claimed in claim 8, wherein the electronic controller is programmed to use pressure data from the pressure sensor to determine an expected granular material flow rate.
